(19) United States
(12) Patent Application Publication
(10) Pub. No.: US 2026/0203550 A1
(43) Pub. Date: Jul. 16, 2026

(54) Artificial Intelligence-Powered Predictive Global Network Management And Operation

(71) Applicant: Google LLC, Mountain View, CA (US)

(72) Inventors: Yun Freund, Cupertino, CA (US); Anurag Sharma, Cupertino, CA (US)

(21) Appl. No.: 19/257,028

(22) Filed: Jul. 1, 2025

Related U.S. Application Data
(60) Provisional application No. 63/745,148, filed on Jan. 14, 2025.

(51) Int. Cl. G06N 3/042; G06N 3/049

(52) U.S. Cl. CPC G06N 3/042; G06N 3/049

(57) ABSTRACT

The technology is directed to systems, methods, and computer-readable mediums for predicting, and in some cases, mitigating or otherwise addressing, effects human-initiated and non-human initated changes to a network may have. One or more temporal network graphs representative of the network may be constructed. One or more temporal network graphs representative of the network with a proposed change may be constructed. An effect on the network the proposed change will have may be predicted using a graph neural network (GNN). The predicted effect may be output.

### CROSS-REFERENCE TO RELATED APPLICATION

The present application claims the benefit of the filing date of U.S. Provisional Ser. No. 63/745,148, filed Jan. 14, 2025, the disclosure of which is hereby incorporated herein by reference.

### BACKGROUND

Network outages frequently stem from operator-initiated changes, a trend observed across various industries. While there have been many network disruptions caused by cybersecurity instances, a high percentage of outages stem from actions like drains of traffic from network segments for repairs, updates, etc., maintenance of network software and equipment, device migrations, and other such repairs and maintenance. Such actions, often performed or initiated at the instruction of network operators, can lead to service disruptions and even network failures. Moreover, such actions by network operators are often subject to rule-based systems, which are often incomplete, offer limited coverage, and are difficult to maintain. The effectiveness of these rule-based systems tends to hinge on the expertise of individual network engineers and operators, making the network's overall performance and operation susceptible to variations in individual skill.

Traditional network operation and management practices typically focus on reacting to problems and repairing them after outages occur. In such scenarios, a goal is to reduce mean time to mitigation (MTTM), which prioritizes quickly restoring service after an outage. This reactive approach emphasizes pinpointing the cause, mitigating the issue, and repairing the damage. Current network operation and management practices are often hindered by their reactive nature, inability to predict the consequences of human actions, and reliance on inflexible rule-based systems. This often leads to costly over-provisioning of resources to ensure stability. Existing approaches struggle to maintain network stability and efficiently manage resources in a dynamic environment.

Network owners and operators often invest in infrastructure with increased capacity and redundancy to mitigate the impact of such disruptions and failures. However, providing such increased capacity and redundancy often requires increased network management and labor, increased capital expenditures on networking equipment and maintenance, and other operational costs, such as increased power usage, etc.

### SUMMARY

The technology described herein is directed to using machine learning models to create a predictive and adaptive network management system. The network management system can predict and prevent network issues before they occur. Such network issues may be caused by actions and events. Such actions and events may be human-initiated, such as network maintenance, or not human-initiated, such as natural disasters, device failures, etc. The machine learning models may be trained to determine whether the predicted effects that changes may have on a network are safe for the network, such that they will improve network operation or otherwise not negatively affect network operation, or unsafe, such that they will degrade the operation of the network. By predicting the effects changes may have on a network, a determination of whether the changes are safe to implement may be made. Unsafe changes may be prevented or otherwise addressed before they affect the network, thereby increasing the mean time between failures (MTBF). Moreover, by predicting potential issues before they occur, the machine learning models described here can minimize downtime and reduce the need for increased network capacity and network redundancy. This proactive approach to managing network management and operation represents a departure from traditional, reactive methods by addressing network issues before they cause problems with the network, such as network outages, and in many cases, before they occur at all.

An aspect of the disclosure is directed to a system comprising one or more computer processors and memory in communication with the one or more computer processors. The memory stores instructions that when executed by the one or more computer processors causes the one or more computer processors to: construct one or more temporal network graphs representative of the network; construct one or more temporal network graphs representative of the network with a proposed change; predict, using a graph neural network (GNN), an effect on the network the proposed change will have; and output the predicted effect.

Another aspect of the disclosure is directed to a method comprising: constructing, by one or more processors, one or more temporal network graphs representative of the network; constructing, by the one or more processors, one or more temporal network graphs representative of the network with a proposed change; predicting, by the one or more processors, using a graph neural network (GNN), an effect on the network the proposed change will have; and outputting, by the one or more processors, the predicted effect.

Another aspect of the disclosure is directed to a computer-readable medium storing instructions that, when executed by one or more processors, cause the one or more processors to: construct one or more temporal network graphs representative of the network; construct one or more temporal network graphs representative of the network with a proposed change; predict using a graph neural network (GNN), an effect on the network the proposed change will have; and output the predicted effect.

In some examples, the GNN is trained, using one or more other temporal network graphs, to predict effects that changes will have on networks.

In some examples, at least one of the one or more temporal network graphs representative of the network is generated using real-time data corresponding to the network.

In some examples, the GNN is trained.

In some examples, the GNN generates one or more actions for mitigating or preventing the predicted effects.

In some examples, the predicted effect includes one or more of: complete or partial network failure; or a reduction or increase in network resources.

### BRIEF DESCRIPTION OF THE DRAWINGS

FIG. 1 is a block diagram of generating a temporal network graph according to aspects of the disclosure.

FIG. 2 is a block diagram illustrating graph neural network(s) processing the temporal network graph of FIG. 1 according to aspects of the disclosure.

FIG. 3 is an illustration of a graph neural network according to aspects of the disclosure.

FIG. 4 illustrates embeddings of nodes and edges of the graph representation of FIG. 3 in a multi-dimensional space according to aspects of the disclosure.

FIG. 5 is a timeline showing temporal changes to the graph representation of a computer network according to aspects of the disclosure.

FIG. 6 illustrates a composite temporal network graph generated from a temporal network graph having a future intent and a temporal network graph having a network state, according to aspects of the disclosure.

FIG. 7 illustrates a graph neural network analyzing the composite temporal network graph of FIG. 6 to predict the effects a future intent will have on a network, according to aspects of the disclosure.

FIG. 8 depicts a flow diagram of an example process for generating a composite temporal network graph and predicting the effects of a future intent using the composite temporal network graph and a graph neural network, according to aspects of the disclosure.

FIG. 9 is a block diagram of a GNN system according to aspects of the disclosure.

FIG. 10 depicts a block diagram of an example environment for a network management system according to aspects of the disclosure.

FIG. 11 depicts a block diagram illustrating one or more model architectures for a network management system according to aspects of the disclosure.

FIG. 12 is a flow diagram illustrating GNNs determining micro and macro insights related to the effect actions and events have on a network according to aspects of the disclosure.

### DETAILED DESCRIPTION

The technology described herein provides a network management system that leverages machine learning (ML) models, such as graph neural networks (GNNs), to predict the effects human-initiated actions and other non-human-initiated events and actions have on a network. The effects predicted by the ML models may include changes to network stability and performance, and changes to network resource management. The predictions generated by the ML models can be used to proactively prevent unsafe changes before they affect the network or to take actions to mitigate the effects of such unsafe changes on the network. By proactively addressing the issues predicted by the ML models before they harm the network, MTBF is increased. By improving MTBF, the need for increased network capacity and redundancy to account for network issues is reduced and, in some instances, removed.

The machine learning model may be trained on temporal network graphs. Temporal network graphs, also referred to herein as temporal digital twins, are virtual models of networks. The models may include representations of network nodes and connections between network nodes, also called “edges.” Temporal digital twins are generated using various types of network data, such as topology (e.g., nodes, connections, etc.), logs, incidents, support tickets, operational and business processes, etc., which are integrated into a heterogeneous graph.

The network data can be continually updated so that one or more temporal digital twins are generated or otherwise updated to provide a dynamic model of the network that reflects the overall state of the network. In this regard, network data may be updated continuously or in regular or irregular time periods. For instance, the network data may be updated every second, minute, half hour, hour, day, or at any other period. In another example, network data may be updated only when the network data changes or a particular network operation, function, or event takes place, such as every time a node passes or receives network data. Temporal digital twin(s) can be updated or generated immediately upon new network data being received, such that the temporal digital twin(s) provides a real-time picture of the network. Alternatively or additionally, temporal digital twin(s) can be updated or generated at regular or irregular time periods, such that they provide an image of the network at a particular time or times.

Temporal digital twins can reflect historical, current, and/or future network states, each of which can include network planning, operations, and business processes. For example, a planned update to a network may be used to update a temporal digital twin such that it reflects the state of the network as if a planned update were implemented, even though the planned update is not implemented on the actual network. In other examples, the network data used to generate a temporal digital twin may be real-time data corresponding to a network, such that the temporal digital twin reflects the current operating state of the network.

Although the examples provided herein describe computer networks, the technology is not so limited. In this regard, while the term “network” can encompass computer networks, the term may also encompass physical and virtual computers and computer networks, enterprise and telecom networks, network business processes, and historical, planned, and current operational states of such networks. Additionally, networks in other verticals such as oil and gas, energy grids, financial networks, etc., can be converted into a graph or a digital twin, and the techniques and features described could be applied to these graphs and/or digital twins.

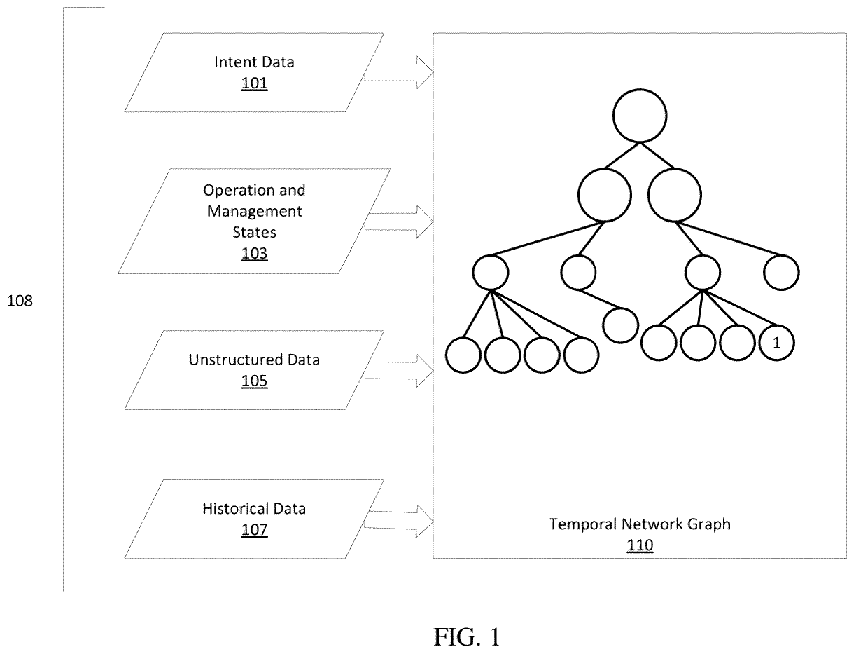

FIG. 1 is a flow diagram illustrating the generation of a temporal network graph 110 using network data 108. Although only a single temporal network graph 110 is shown, any number of temporal network graphs may be generated. As shown, network data 108 may include intent 101, operation and management states of the network 103, unstructured data 105, and historical data 107. The network data 101-107 may be used to generate temporal network graph 110, a temporal digital twin of a network. Although only a single temporal network graph is shown, any number of temporal network graphs may be generated using any combination of network data 101-107.

Intent data 101 may include data that represents planned changes or human interventions, such as maintenance activities for the network. Intent data may include expected operational parameters of the network. For example, intent data 101 may include data that represents planned link capacities (e.g., in GB/s, Gbps, MB/s, Mbps, etc), expected latencies, and expected network states such as operational and administrative states. Additionally, intent data could include expected device and card deployments, bug states (e.g., “bug pending, but should have been answered within 24 hours”), and having (or not having) critical or major alarms on the device.

Operation and management states of the network 103 may include data related to the real-time status of the intent data 101. For example, current/effective capacities, latencies, current bug state, current major and critical alarms/faults, currently deployed cards and devices, etc. Unstructured data 105 may include data that does not have a predefined format or structure. Examples of unstructured data include device logs, controller logs, syslogs, information in bug trackers or support tickets, device documentation/manuals, legal contracts (e.g., leased assets contracts), etc., corresponding to network devices

Historical data 107 may include telemetry data and labels. Examples of telemetry data include various counter types and values collected from devices, controllers, and other network entities. Such telemetry data provides insight into the operational state of equipment and programs. Examples of telemetry data may include packets transmitted/received, packets dropped, Pre-FEC BER, and other such counter types. The historical data, like other network data 108, may be collected periodically or in real time, such as when pushed by the network entities.

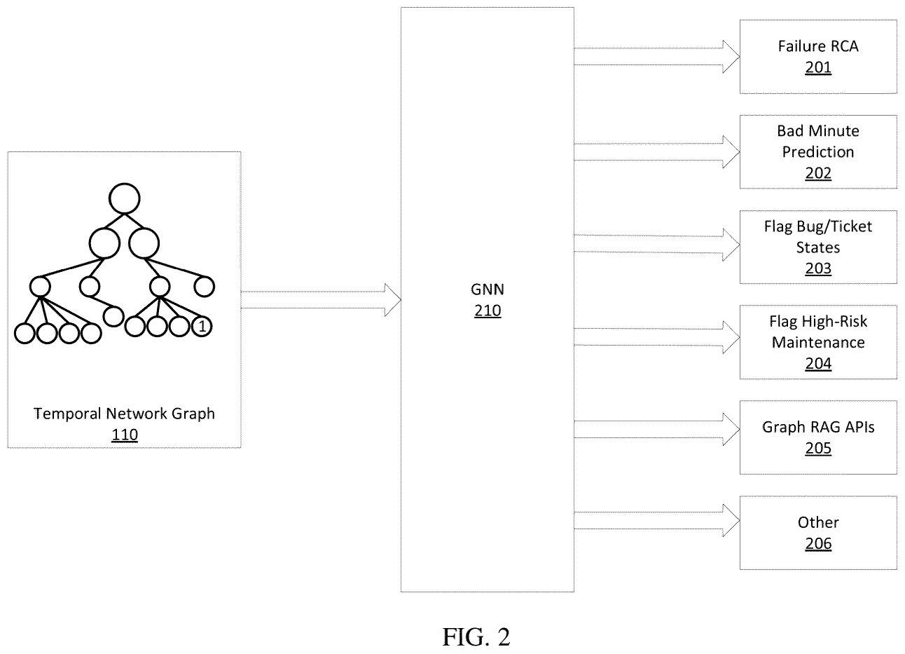

A machine learning model may be trained, utilizing temporal digital twins, such as temporal network graph 110, to perform predictive maintenance, such as forecasting potential problems, preventing outages, and proactively mitigating risks. FIG. 2 is a flow diagram illustrating machine learning models, including GNN 210, using temporal network graph 110 to predict or identify issues within a network. Although FIG. 2 illustrates a single GNN 210, any number of GNNs may be trained. In this regard, a single GNN model may cater to multiple tasks or use cases, or multiple GNN models may be employed, with each focused on a specific task. Additionally, GNNs might provide outputs, such as embeddings, that an application layer could consume to build out a use case.

For instance, and as shown in FIG. 2, GNN 210 may be trained to identify failure root cause analysis (RCA) 201, bad minute prediction 202, flag bug and/or ticket states 203, flag high-risk maintenance 204, graph retrieval augmented generation (RAG) APIs 205, and other issues, as illustrated by block 206.

An example failure RCA 201 may be a router, port, or other network entity that is the root cause of a network issue. In some examples, the root cause of a network issue may be software-related, such as a new software update.

A bad minute prediction 202 refers to traffic impacted between locations (or some A-End and Z-End entities within the network). This impact is captured in the form of bad minutes 202.

Flag bug and/or ticket states 203 refers to bugs and tickets that might not be in their expected state. Flag bug and/or ticket state 203 may include correspondence or data associated with vendors that may not include all information that is required by or from the vendors.

Flag high-risk maintenance 204 refers to flagging parts of the graph (subgraph), possibly using heatmaps, to show any potential impact of the upcoming maintenance.

RAG APIs 205 refers to the ability of a user to ask questions in natural language and receive responses from the graph entities and their neighbors.

Graph neural networks, such as GNN 210, excel at deciphering the complex relationships within heterogeneous graphs, such as temporal digital twins. Thus, GNNs are well-suited to identify network traffic patterns, network device behaviors, and anomalies within a network that may indicate an impending problem. The GNNs may be trained using supervised, unsupervised, semi-supervised, and/or self-supervised learning. Through training, GNN models can develop deep network expertise by analyzing historical data, enabling them to predict and prevent future issues.

GNNs are also well suited to adaptively learn to predict unexpected events, proactively mitigate risks, and optimize network performance. This adaptability is well-suited for operation in dynamic environments, such as large-scale networks, which are typically subjected to evolving demands from cloud computing, new architectures, and emerging applications.

GNN 210 may be trained using temporal digital twins. In this regard, based on the data included in the temporal digital twins, such as network intent, real-time operational and management information, unstructured data, and historical data, GNN 210 may determine relationships between different aspects of the converged network, including planning, operations, and business processes.

Additionally, GNN 210 may be trained to identify both healthy and failure states within the network by analyzing historical data and generating representative embeddings, as discussed further herein. These learned embeddings can then be used to predict whether human-initiated changes or other non-human-initiated changes to the network will lead to outages or degradations in network performance. For instance, for human-initiated changes, the GNN 210 may be trained to predict the potential impact on end customers of the network, the sub-graph would become unstable, and/or the device or graph entity that would result in unstable behavior due to the change. For non-human-initiated actions, ML models may be able to predict device or graph entity failures, customer impacts resulting from the device or graph entity failures, and/or network blast radius.

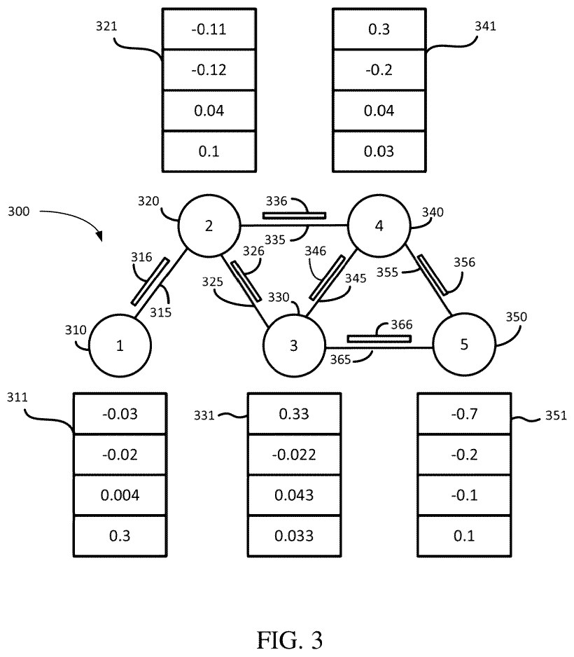

FIG. 3 illustrates an example of embeddings of a GNN where the GNN is trained to generate node embeddings using message passing. The temporal network graphs consist of multiple snapshots taken at different times. The GNN can be trained using these multiple snapshots from the temporal network graphs.

As shown in FIG. 3, network entities of network 300 include nodes 310, 320, 330, 340, and 350 and edges 315, 325, 335, 345, 355, and 365. The nodes 310, 320, 330, 340, 350 represent network devices or entities, while edges 315, 325, 335, 345, 355, and 365 define connections between the network devices or entities. For example, edge 315 represents a connection between nodes 310 and 320, while edge 335 represents a connection between nodes 320 and 340. Although only five nodes and six edges are shown in network 300, a network may include any number of edges and nodes.

In some embodiments, a GNN may be generated from subsets of nodes and/or edges of a network. For instance, a first GNN may be generated for a first portion of a network, a second GNN may be generated for a second portion of a network, and a third GNN may be generated for the entire network, which may include the first and second portions.

As further shown in FIG. 3, each node 310, 320, 330, 340, 350 is associated with a corresponding embedding 311, 321, 331, 341, 351, respectively. Embeddings 311, 321, 331, 341, 351 capture state information of the corresponding node and attached edges in high-dimensional space. Embeddings 311, 321, 331, 341, 351 encode information related to attributes and structural information of the nodes and edges associated with a given node. Embeddings 311, 321, 331, 341, 351 may provide structural information regarding components that make up the network. Attributes can include settings and parameters associated with the network device associated with a node and/or edges associated with a given node. Additionally, operating states, including network traffic metrics and management states, may be used to establish appropriate embeddings.

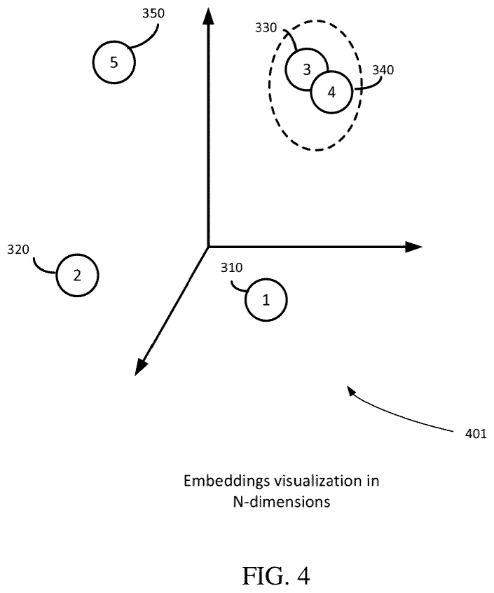

As the network model evolves, the GNN may be updated over time. In this regard, messages 316, 326, 336, 346, 356, and 366 are communicated between nodes 310, 320, 330, 340, 350 to provide context and semantic information, which is used to update the embeddings 311, 321, 331, 341, 351. Referring to the embeddings 311, 321, 331, 341, 351, a visualization 401 of nodes 310, 320, 130, 340, 150 may be generated in n-dimensional space. Nodes having similar embeddings, for example a network device of the same make, model and configuration settings will inhabit similar spaces in the visualization 401, as shown in FIG. 4. As seen in the visualization 401, node 330 and node 340 are proximate to each other, signifying that node 330 and node 340 are similar nodes sharing similar contexts within the network.

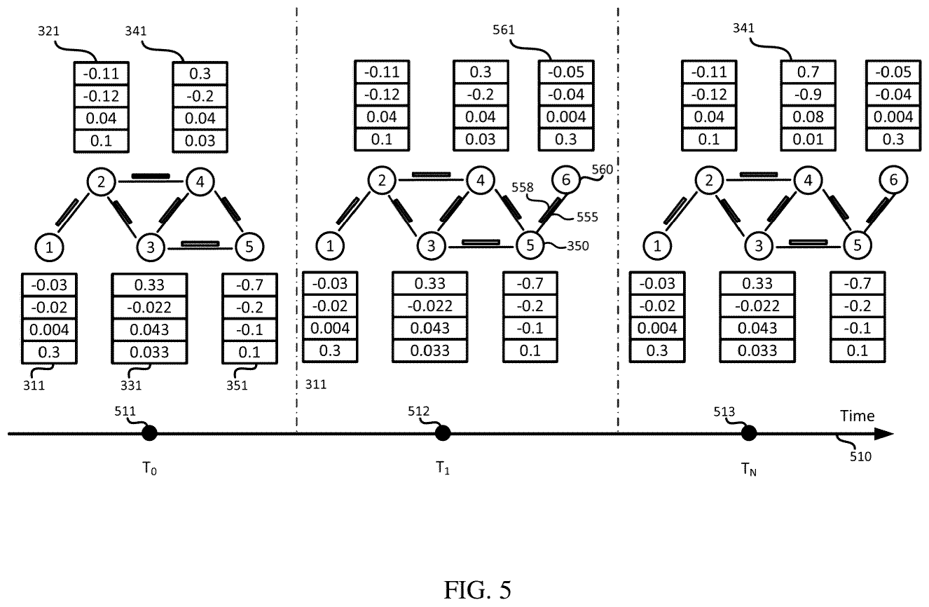

FIG. 5 illustrates the changes over time in the GNN embeddings of FIG. 3. FIG. 5 illustrates an evolution of the GNN along timeline 510. The evolution occurs as network changes occur at times T₀ 511, T₁ 512, and T_{N} 513. At time T₁ 512, an additional node 560 is added to the network along with its associated edge 555 and messaging pathway 558 connecting node 560 to node 350. A new embedding 561 is associated with the new node 560. At later time T_{N} 513, it is observed that the values in the embedding 341 associated with node 340 have changed. Embedding may be leveraged by the machine learning models described herein, such as GNN 210, to predict the effects of human initiated actions or other problems with the network and applying that knowledge to automatically generate corrective actions, such as alerting a network manager or altering the operation of the network to account for the predicted network problems. For instance, an embedding may be expected to have a particular value, and if the embedding is not that particular value or a threshold amount away from the particular value, the GNN may determine a problem has occurred or will occur.

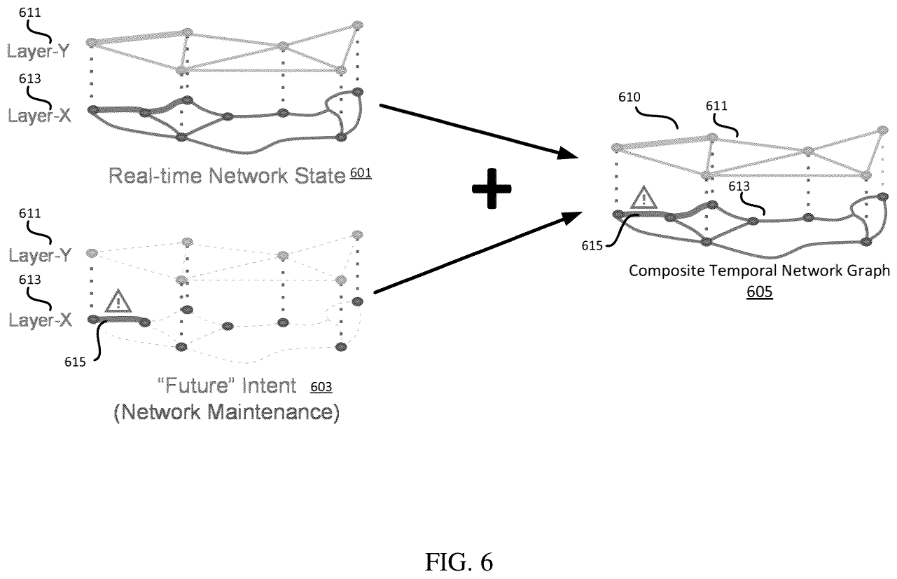

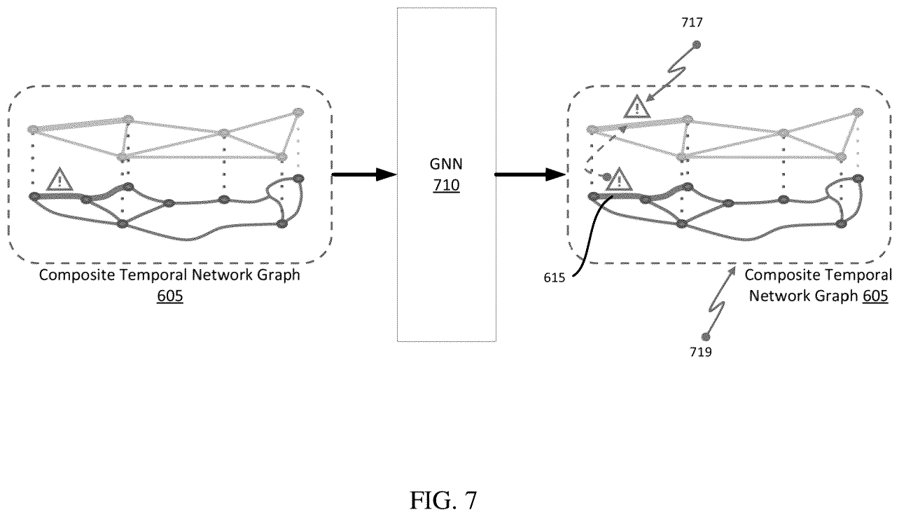

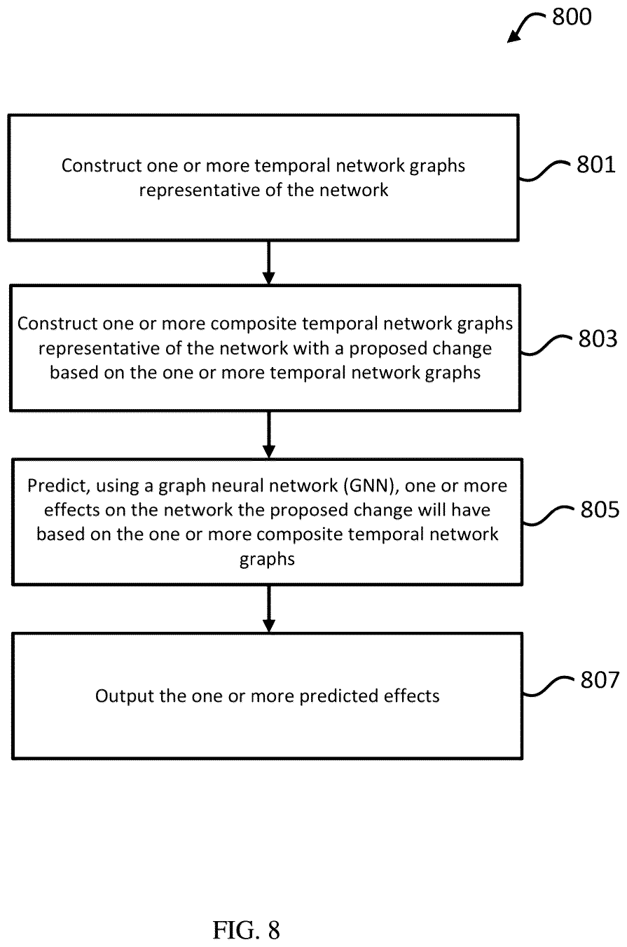

FIG. 6 illustrates generating temporal network graphs, which are then combined into a composite temporal network graph. FIG. 7 illustrates the composite temporal network graph being processed by a GNN 710, which may be compared to GNN 210, to predict the effects a future intent has on a network. FIG. 8 is a flow diagram 800 outlining the steps shown in FIGS. 6 and 7.

As shown in block 801 of FIG. 8, temporal network graphs are generated. Referring to FIG. 6, two temporal network graphs are generated, 601 and 603. Temporal network graph 601 represents the real-time network state of a network having two layers, layer-Y 611 and layer-X 613, and depicts the complex relationships between different elements in the network. Temporal network graph 603 represents a future intent 615 being implemented on a section of layer-X 613. The future intent 615 represents a future production change request (PCR), a typical type of network maintenance. This PCR may include replacing a line card on the edge of layer-X. In other words, temporal network graph 603 represents a portion of the network as if the future intent 615 has been implemented. PCRs and other such network maintenance events are only a subset of possible future intents. Other future intents may include planned changes or human interventions.

As shown in block 803 of flow diagram 800 of FIG. 8, a temporal composite graph is generated from the temporal network graphs. Referring again to FIG. 6, temporal network graphs 601 and 603 are combined into a composite temporal network graph 605. Composite temporal network graphs may be created from any number of temporal network graphs. For instance, a composite temporal network graph may be generated from a portion of a single temporal network graph, from two or more complete temporal network graphs, or any combination of complete or partial temporal network graphs. Composite temporal network graph 605, shown in FIG. 6, represents the real-time network state as found in temporal network graph 601, but with the future intent 615 on an edge of layer-X as shown in temporal network graph 603.

As shown in block 805 of flow diagram 800 of FIG. 8, a graph neural network is used to predict the effects on the network that the proposed change, the future intent, will have on the network. In this regard, and as shown in FIG. 7, the composite temporal network graph is provided to GNN 710, which may be compared to GNN 210. GNN 710 may analyze the data corresponding to the composite temporal network graph 710, such as the embeddings, and predict potential impacts the future intent 615 may have across portions, parts, components, etc., of the network. For instance, GNN 710 may identify that the line card being replaced in Layer-X handles a significant amount of traffic for a critical application running in Layer-Y. The GNN 710 may further determine that the downtime to replace the line card will negatively impact the critical application, as indicated by 717. Consistent with block 807 of FIG. 7, the GNN may provide such assessments for an operator to address or automatically take actions to mitigate or remove the risks associated with the maintenance. Such assessments may include an indication, such as a visual or audible notification, that the critical application running in Layer-Y will be negatively impacted by the future intent 615.

The GNN 710 may, additionally or alternatively, assess whether the resulting network state is “safe” at the network or partial network level by identifying potential issues arising from the planned changes. For example, it might determine whether there is sufficient protection capacity for the maintenance to proceed, as illustrated by 719, without negatively affecting the operation of the critical application, or if existing capacity shortfalls make the maintenance risky. The GNN 710 may output such assessments for an operator to address or automatically take actions to mitigate or remove the risks associated with the maintenance, consistent with block 807 of FIG. 8.

By assessing future intents, such as planned maintenance, the GNN 710 may provide insights to proactively prevent network failures and ensure the network operates safely. Moreover, by predicting the impact of planned changes and preventing potential outages, GNN 710 will enhance network reliability (increase MTBF) and optimize resource utilization (reduce network protection requirements).

Although a single composite temporal network graph 605 is shown as being provided to GNN 710, any number of composite temporal network graphs or temporal network graphs may be provided to the GNN. Moreover, although FIG. 7 illustrates only a single GNN 710, any number of GNNs may be used to process the composite temporal network graphs and/or temporal network graphs. Each GNN may be trained to predict particular failures or network safety risks using composite and other temporal network graphs.

GNNs may be trained to determine insights related to the effects individual events or actions have on a network, referred to herein as micro insights. Such micro insights may include determining possible outages due to human actions within a network. GNNs may also be trained to determine insights related to the effects that many events or actions have on a network, referred to herein as macro insights.

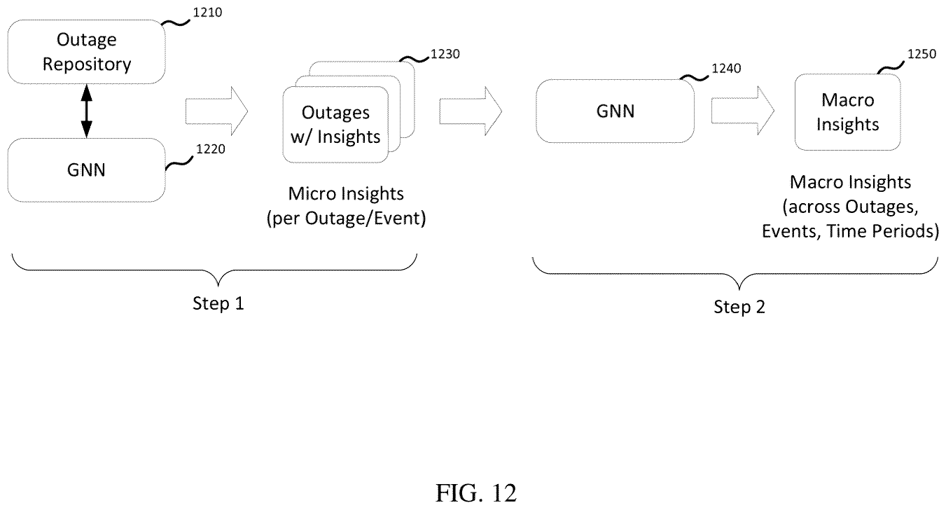

Referring to FIG. 12, an ML model, GNN 1220, is trained to process data stored in an outage repository 1210. Such training may be done using some or all of the data stored in an outage repository. The outage repository 1210 may be stored in a datacenter or on a server or other computing device. The outage repository may store temporal network graphs, composite temporal network graphs, and/or predicted effects a future intent may have on a network or the safety of the network, such as predicted effects determined by GNNs 210 and 710. Micro insights 1230 may be computed for each outage, i.e., the timeframe is constrained by the duration of the outage, as shown in Step 1. For instance, if a network card X1 causes a 5-minute outage at 11:00 am and network card X2 causes a 2-minute outage at 1:00 pm, each outage and its cause may be considered a micro insight.

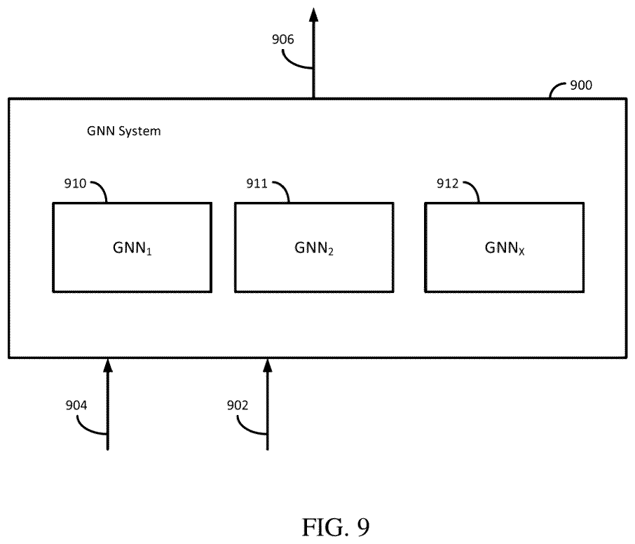

The same ML model or another ML model, such as GNN 1240, may analyze insights from individual micro insights and generate macro insights 1250. Macro insights, such as 1250, may be computed across outages, events, and time periods, as shown in Step 2. That is, macro insights capture details at a higher level than micro insights, which are insights per each event/outage. Continuing the above example, if network cards X1 and X2 belonged to the same device, then the macro insight over a longer window, for example, 12 hours, may determine that the frequency of failure for device X is higher than expected and has caused N bad minutes. ML models 1220 and 1240 may be trained similarly to GNNs described herein with reference to FIG. 9.

FIG. 9 depicts a block diagram of an example GNN system 900, which can be implemented on one or more computing devices. The GNN system 900 can be configured to receive inference data 904 and/or training data 902 for use in training and executing GNNs 910-912, which may be compared to GNNs 10 and 710. For example, the GNN system 900 can receive the inference data 904 and/or training data 902 as part of a call to an application programming interface (API) exposing the GNN system 900 to one or more computing devices. Inference data and/or training data can also be provided to the GNN system 900 through a storage medium, such as remote storage connected to the one or more computing devices over a network. Inference data 904 and/or training data 902 can further be provided as input through a user interface on a client computing device coupled to the GNN system 900.

The inference data 904 can include data associated with temporal network graphs, including any historical temporal network graphs corresponding to past network conditions and configurations, real-time temporal network graphs corresponding to current network conditions and configurations, and or future temporal network graphs corresponding to intended changes to network conditions and configurations.

The training data 902 can correspond to an artificial intelligence (AI) or machine learning task for predicting potential issues and risks associated with changes to a network. Such training data may include temporal network graph data, including current, future, and/or past temporal network graphs. The training data 902 can be split into a training set, a validation set, and/or a testing set. An example training/validation/testing split can be an 80/10/10 split, although any other split may be possible. The training data can include examples of issues and risks associated with changes to the network. Training data may also originate from external sources, including other GNN models focused on anomaly detection. Training data may include historical structured data relating to states of the system. This would include past experiences of issues, such that the training data includes examples of normal system operations and abnormal conditions. Further prior resolutions of abnormal conditions may be contained in unstructured information such as past repair tickets, repair books, and previously identified root causes for the abnormal conditions. Relationships between these types of data are learned by the neural network and provide a basis for future detection, identification, and remediation of abnormalities that may be predicted to arise.

The training data 902 can be in any form suitable for training a model, according to one of a variety of different learning techniques. Learning techniques for training a model can include supervised learning, unsupervised learning, and semi-supervised learning techniques. For example, the training data 902 can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, if the machine learning task is a classification task, the training examples can be images labeled with one or more classes categorizing subjects depicted in the images. As another example, a supervised learning technique can be applied to calculate an error between outputs with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

The output data can include instructions associated with the predicted risk and/or issues with particular actions or events, whether human or non-human initiated. As an example, the GNN system 900 can be configured to send the output data 906 for display on a client or user display. As another example, the GNN system 900 can be configured to provide the output data 906 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The GNN system 900 can further be configured to forward the output data 906 to one or more other devices configured for translating the output data 906 into an executable program written in a computer programming language. The GNN system 900 can also be configured to send the output data 906 to a storage device for storage and later retrieval.

From the inference data 904 and/or training data 902, the GNN system 900 can be configured to output one or more results related to the effects a change may have on a network, as well as potential ways to mitigate or prevent changes that negatively affect the network, as output data. As examples, the output data can be any kind of score, classification, or regression output based on the input data. Correspondingly, the AI or machine learning task can be a scoring, classification, and/or regression task for predicting some output given some input. These AI or machine learning tasks can correspond to a variety of different applications in processing images, video, text, speech, or other types of data to predict risks and issues associated with network changes.

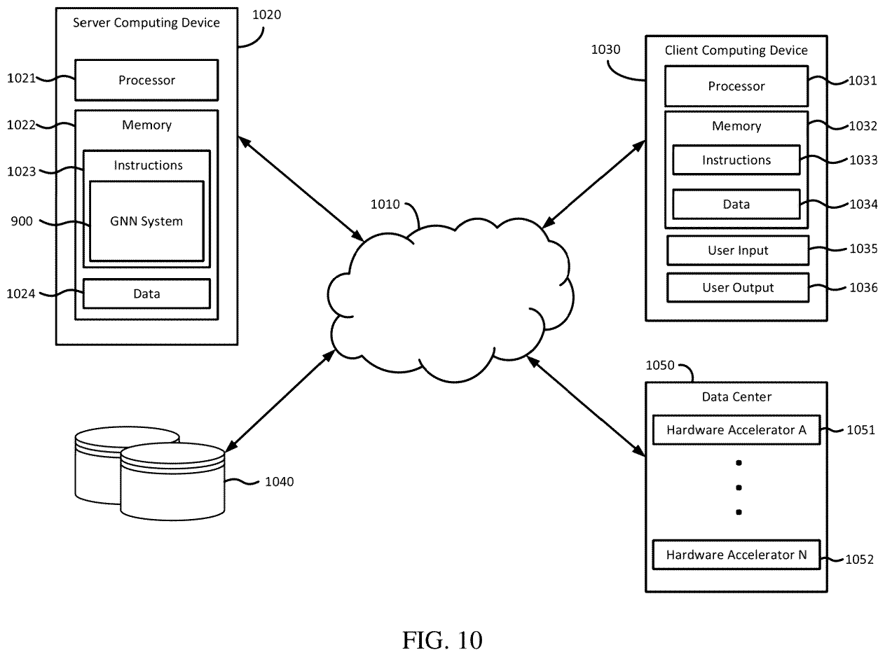

FIG. 10 depicts a block diagram of an example environment for implementing an GNN system 900. The GNN system 900 can be implemented on one or more devices having one or more processors in one or more locations, such as in server computing device 1020. Client computing device 1030 and the server computing device 1020 can be communicatively coupled to one or more storage devices 1040 over a network 1010. The storage devices 1040 can be a combination of volatile and non-volatile memory and can be at the same or different physical locations than the computing devices 1020, 1030. For example, the storage devices 1040 can include any type of non-transitory computer readable medium capable of storing information, such as a hard-drive, solid state drive, tape drive, optical storage, memory card, ROM, RAM, DVD, CD-ROM, write-capable, and read-only memories. Although FIG. 10 illustrates a single network 1010, a single server computing device 1020, a single client computing device 1030, and a single data center 1050, the environment can include any number of computing devices, networks, and data centers.

The server computing device 1020 can include one or more processors and memory. The memory can store information accessible by the processors 1021, 1031, including instructions 1023, 1033 that can be executed by the processors 1021, 1031. The memory 1022, 1032 can also include data 1024, 1034 that can be retrieved, manipulated, or stored by the processors 1021, 1031. The memory 1022, 1032 can be a type of non-transitory computer readable medium capable of storing information accessible by the processors, such as volatile and non-volatile memory. The processors can include one or more central processing units (CPUs), graphic processing units (GPUs), field-programmable gate arrays (FPGAs), and/or application-specific integrated circuits (ASICs), such as tensor processing units (TPUs).

The instructions 1023, 1033 can include one or more instructions 1023, 1033 that, when executed by the processors 1021, 1031, cause the one or more processors 1021, 1031 to perform actions defined by the instructions 1022, 1032. The instructions can be stored in object code format for direct processing by the processors 1021, 1031, or in other formats including interpretable scripts or collections of independent source code modules that are interpreted on demand or compiled in advance. The instructions 1022, 1032 can include instructions for implementing a GNN system 900, which can correspond to the GNN system 900 of FIG. 9. The GNN system 900 can be executed using the processors, and/or using other processors remotely located from the server computing device 1020.

The data 1024, 1034 can be retrieved, stored, or modified by the processors 1021, 1031 in accordance with the instructions 1022, 1032. The data 1024, 1034 can be stored in computer registers, in a relational or non-relational database as a table having a plurality of different fields and records, or as JSON, YAML, proto, or XML documents. The data can also be formatted in a computer-readable format such as, but not limited to, binary values, ASCII, or Unicode. Moreover, the data can include information sufficient to identify relevant information, such as numbers, descriptive text, proprietary codes, pointers, references to data stored in other memories, including other network locations, or information that is used by a function to calculate relevant data.

The client computing device 1030 can also be configured similarly to the server computing device 1020, with one or more processors 1031, memory 1032, instructions 1033, and data 1034. The client computing device 1030 can also include a user input 1035 and a user output 1036. The user input 1035 can include any appropriate mechanism or technique for receiving input from a user, such as keyboard, mouse, mechanical actuators, soft actuators, touchscreens, microphones, and sensors.

The server computing device 1020 can be configured to transmit data to the client computing device 1030, and the client computing device 1030 can be configured to display at least a portion of the received data on a display implemented as part of the user output 1036. The user output 1036 can also be used for displaying an interface between the client computing device 1030 and the server computing device 1020. The user output 1036 can alternatively or additionally include one or more speakers, transducers or other audio outputs, a haptic interface or other tactile feedback that provides non-visual and non-audible information to the platform user of the client computing device.

Although FIG. 10 illustrates the processors 1021, 1031 and the memories 1022, 1032 as being within the computing devices 1020, 1030, components described herein can include multiple processors and memories that can operate in different physical locations and not within the same computing device. For example, some of the instructions and the data can be stored on a removable SD card and others within a read-only computer chip. Some or all of the instructions and data can be stored in a location physically remote from, yet still accessible by, the processors. Similarly, the processors can include a collection of processors that can perform concurrent and/or sequential operations. The computing devices can each include one or more internal clocks providing timing information, which can be used for time measurement for operations and programs run by the computing devices.

The server computing device 1020 can be connected over the network 1010 to a data center 1050 housing any number of hardware accelerators 1051-1052. The data center 1050 can be one of multiple data centers or other facilities in which various types of computing devices, such as hardware accelerators 1051-1052, are located. Computing resources housed in the data center 1050 can be specified for deploying GNN models related to proactively preventing failures and ensuring a network safely operates, such as GNNs 210 and 710, as described herein.

The server computing device 1020 can be configured to receive requests to process data from the client computing device 1030 on computing resources in the data center 1050. For example, the environment can be part of a computing platform configured to provide a variety of services to users, through various user interfaces and/or application programming interfaces (APIs) exposing the platform services. The variety of services can include predicting failures and ensuring network safety. The client computing device 1030 can transmit input data associated with such services to GNN system 900, which can in turn analyze such input data to predict failures and ensure network safety. In some instances, the GNN system 900 may generate output data identifying predicted failures or network safety concerns and, in some instances, instructions for remedying such.

As other examples of potential services provided by a platform implementing the environment, the server computing device 1020 can maintain a variety of models in accordance with different constraints available at the data center 1050. For example, the server computing device 1020 can maintain different families for deploying models on various types of TPUs and/or GPUs housed in the data center 1050 or otherwise available for processing.

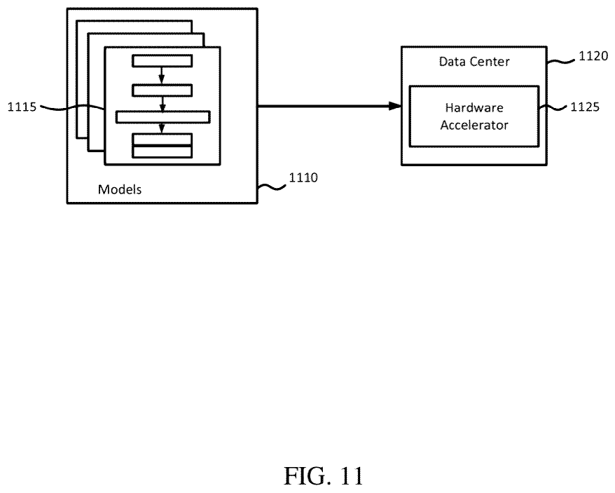

FIG. 11 depicts a block diagram illustrating one or more model architectures 1115, such as for deployment in a data center 1120 housing a hardware accelerator 1125 on which the deployed models 1110 will execute for predicting failures and ensuring network safety. The hardware accelerator can be any type of processor, such as a CPU, GPU, FPGA, or ASIC such as a TPU.

An architecture of a model 1115 can refer to characteristics defining the model, such as characteristics of layers for the model, how the layers process input, or how the layers interact with one another. For example, the model can be a graph neural network, as described herein.

Referring back to FIG. 10, the devices 1020, 1030, and the data center 1050 can be capable of direct and indirect communication over the network 1010. For example, using a network socket, the client computing device 1030 can connect to a service operating in the data center 1050 through an Internet protocol. The devices can set up listening sockets that may accept an initiating connection for sending and receiving information. The network 1010 itself can include various configurations and protocols including the Internet, World Wide Web, intranets, virtual private networks, wide area networks, local networks, and private networks using communication protocols proprietary to one or more companies. The network can support a variety of short-and long-range connections. The short-and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network, in addition or alternatively, can also support wired connections between the devices and the data center, including over various types of Ethernet connection.

Although a single server computing device 1020, client computing device 1030, and data center 1050 are shown in FIG. 10, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing optimization models, and any combination thereof.

Aspects of the disclosure can be implemented in digital electronic circuitry, in tangible computer software or firmware, and/or in computer hardware, such as the structure disclosed herein, their structural equivalents, or combinations thereof. Aspects of the disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed on its software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back-end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

Neural networks are machine learning models that include one or more layers of nonlinear operations to predict an output for a received input. In addition to an input layer and an output layer, some neural networks include one or more hidden layers. The output of each hidden layer can be input to another hidden layer or the output layer of the neural network. Each layer of the neural network can generate a respective output from a received input according to values for one or more model parameters for the layer. The model parameters can be weights or biases that are determined through a training algorithm to cause the neural network to generate accurate output.

1. A system comprising:
one or more computer processors;
a memory in communication with the one or more computer processors, the memory storing instructions that, when executed by the one or more computer processors, causes the one or more computer processors to:
construct one or more temporal network graphs representative of the network;
construct one or more composite temporal network graphs representative of the network with a proposed change based on the one or more temporal network graphs;
predict, using a graph neural network (GNN), one or more effects on the network the proposed change will have based on the one or more composite temporal network graphs; and
output the one or more predicted effects.

2. The system of claim 1, wherein the GNN is trained, using one or more other temporal network graphs and/or one or more other composite temporal network graphs, to predict effects that changes have on networks.

3. The system of claim 2, wherein the instructions further comprise training the GNN.

4. The system of claim 1, wherein at least one of the one or more temporal network graphs representative of the network is generated using real-time data corresponding to the network.

5. The system of claim 1, wherein the GNN generates one or more actions for mitigating or preventing the one or more predicted effects.

6. The system of claim 1, wherein the predicted effect includes one or more of:
complete or partial network failure; or
a reduction or increase in network resources.

7. A method comprising:
constructing, by one or more processors, one or more temporal network graphs representative of the network;
constructing, by the one or more processors, one or more temporal network graphs representative of the network with a proposed change;
predicting, by the one or more processors, using a graph neural network (GNN), an effect on the network the proposed change will have; and
outputting, by the one or more processors, the predicted effect.

8. The method of claim 7, wherein the GNN is trained, using one or more other temporal network graphs, to predict effects that changes have on networks.

9. The method of claim 7, further comprising:
training, by the one or more processors, the GNN.

10. The method of claim 7, wherein at least one of the one or more temporal network graphs representative of the network is generated using real-time data corresponding to the network.

11. The method of claim 7, wherein the GNN generates one or more actions for mitigating or preventing the predicted effects.

12. The method of claim 7, wherein the predicted effect includes one or more of:
complete or partial network failure; or
a reduction or increase in network resources.

13. A computer-readable medium storing instructions that, when executed by one or more processors, cause the one or more processors to:
construct one or more temporal network graphs representative of the network;
construct one or more temporal network graphs representative of the network with a proposed change;
predict using a graph neural network (GNN), an effect on the network the proposed change will have; and
output the predicted effect.

14. The computer-readable medium of claim 13, wherein the GNN is trained, using one or more other temporal network graphs, to predict effects that changes have on networks.

15. The computer-readable medium of claim 13, wherein the instructions further cause the one or more processors to train the GNN.

16. The computer-readable medium of claim 13, wherein at least one of the one or more temporal network graphs representative of the network is generated using real-time data corresponding to the network.

17. The computer-readable medium of claim 13, wherein the GNN generates one or more actions for mitigating or preventing the predicted effects.

18. The computer-readable medium of claim 13, wherein the predicted effect includes one or more of:
complete or partial network failure; or
a reduction or increase in network resources.
